(19) United States
(12) Patent Application Publication
(10) Pub. No.: US 2007/0192219 A1
(43) Pub. Date: Aug. 16, 2007

(54) CONSUMER INVESTING PROGRAM UTILIZING SPECIAL OFFERS, REBATES AND DISCOUNTS

(76) Inventors: Raymond White, Santa Clarita, CA (US); Cynthia White, Santa Clarita, CA (US); Ruben Moskovyan, Granada Hills, CA (US); Clifford Ball, Monrovia, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/307,675

(22) Filed: Feb. 16, 2006

(51) Int. Cl. G06Q 40/00

(52) U.S. Cl. 705/35

(57) ABSTRACT

A process of consumer investing under a plan participated in by a consumer and a commercial entity, and administered by a banking and/or investment entity includes entering into an agreement between the consumer and the banking and/or investment entity whereby the consumer becomes a member of the plan. A commercial transaction is completed between the member and the commercial entity. A monetary reward is generated on completion of the commercial transaction. The monetary reward is transferred to the banking and/or investment entity under the plan. The member is educated about uses for funds accumulated by the member under the plan; and specified accumulated funds associated with the member are directed for a purpose designated by the member.

### BACKGROUND OF THE INVENTION

The present invention generally relates to tools and techniques for promoting consumer savings and investment. More particularly, the present invention relates to a consumer investment program utilizing monetary rewards offered to consumers as part of commercial transactions.

Methods for promoting savings and investment are generally known in the art. For example, U.S. Pat. No. 6,631,358 discloses tools and techniques for directing funds on behalf of a customer to a specified account as a beneficial side-effect of a transaction that is primarily directed toward another goal, such as the purchase of merchandise or services. However, this merely uses funds derived solely as a direct percentage of a monetary transaction, does not use a variety of incentives, does not provide financial education to the customer, and does not allow the customer to direct the funds without limitation. In another example, U.S. Pat. No. 6,345,261 discloses a customer loyalty investment program system and method where purchase rebates are used to provide the customer with an important fund including merchant securities. However, these rebates are invested solely in a specific fund which includes the merchant's equity, does not provide financial education to the customer, and does not allow the customer to direct the funds without limitation. It is well-known for credit card companies to provide consumers with cash-back savings on purchases and/or to offer cardholders points equivalent to a fraction of the monetary value of the purchases made by the cardholder with the cardholder being able to later redeeming their accumulated points in exchange for goods or services offered by the credit card company in a catalogue.

Accordingly, there is a need for a method that allows a consumer to invest a variety of monetary rewards associated with commercial transactions. There is a further need for a method that allows a consumer to accumulate funds derived from monetary rewards associated with commercial transactions. There is an additional need for a method that allows a consumer to accumulate funds derived from monetary rewards associated with commercial transactions and direct those funds as desired. There is a need for a method that educates consumers in investment and savings structures. The present invention fulfills these needs and provides other related advantages.

### SUMMARY OF THE INVENTION

The present invention resides in a method for saving and investing through the use of monetary rewards including, without limitation, special offers, rebates, coupons, loyalty cards, discounts offered by retailers, stores, merchants, wholesalers, credit issuers and companies as part of commercial transactions.

The present invention discloses a process of consumer saving and investing under a plan participated in by a consumer and a commercial entity, and administered by a banking and/or investment entity. An agreement is entered into between the consumer and the banking and/or investment entity whereby the consumer becomes a member of the plan. A commercial transaction is completed between the member and the commercial entity. A monetary reward is generated on completion of the commercial transaction. The monetary reward is transferred to the banking and/or investment entity under the plan. The member is educated about uses for funds accumulated by the member under the plan; and specified accumulated funds associated with the member are directed for a purpose designated by the member.

At the request of the consumer, an account is opened under the plan. The account is administered by the banking and/or investment entity on behalf of the member. As part of the process, a non-plan account associated with the member is linked to the plan.

As part of completing the commercial transaction, the commercial transaction is linked with an account associated with the member under the plan. During the commercial transaction, the consumer is identified as a member of the plan.

The monetary reward is received into the account associated with the member participating in the commercial transaction, as part of transferring the monetary reward. The transference is performed by the commercial entity. The monetary reward transferred under the plan is fully vested at the time of transfer.

Freedom is provided to the member on use and direction of the specified funds. For example, the consumer may direct that the specified funds be automatically transferred in response to a designated amount being accumulated under the plan. In another example, an investment or savings vehicle may be opened on behalf of the member at the direction of the member.

The member is provided financial education by the banking and/or investment entity.

The plan is not limited to monetary rewards and the member may contribute funds other than the monetary reward to the account under the plan.

Other features and advantages of the present invention will become apparent from the following more detailed description, taken in conjunction with the accompanying drawings which, by way of example, illustrate the principles of the invention.

### BRIEF DESCRIPTION OF THE DRAWINGS

The accompanying drawings illustrate the invention. In such drawings:

FIG. 1 is a flow chart illustrating an embodiment of the present invention;

FIG. 2 is a flow chart detailing becoming a plan member;

FIG. 3 is a flow chart further detailing a member transaction under the plan;

FIG. 4 is a flow chart providing further detail regarding cash contributions under the plan;

FIG. 5 is a flow chart additionally detailing deposits to member accounts under the plan;

FIG. 6 is a flow chart illustrating direction of funds by the member; and

FIG. 7 is a flow chart regarding the education component of FIG. 1.

### DETAILED DESCRIPTION OF THE PREFERRED EMBODIMENT

A system and method are disclosed for saving and investing through monetary rewards associated with completion of a commercial transaction by a consumer. These monetary rewards include, without limitation, special offers, purchase incentives, rebates, coupons, loyalty cards, discounts or the like offered by various commercial entities including, without limitation, retailers, stores, merchants, wholesalers, credit issuers, companies or the like. The system includes linking consumers with commercial entities and financial companies administered by a banking and/or investment entity. Consumers making purchases at merchants, retailers, stores, wholesalers and companies can use coupons, retail savings cards, loyalty cards, credit incentives and rebates to invest the savings amount into a saving/investment vehicle by electronic or other means.

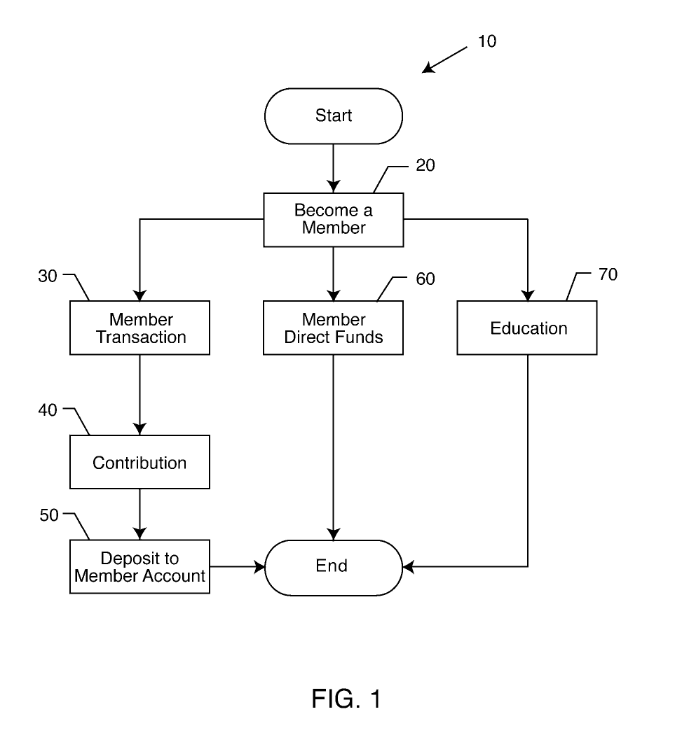

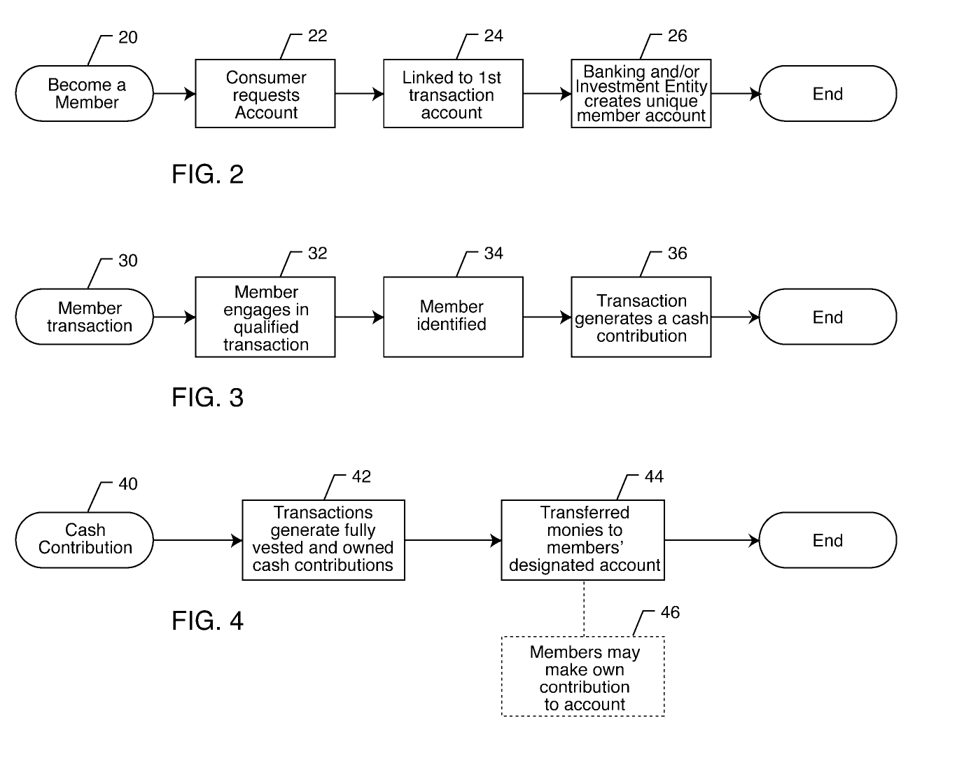

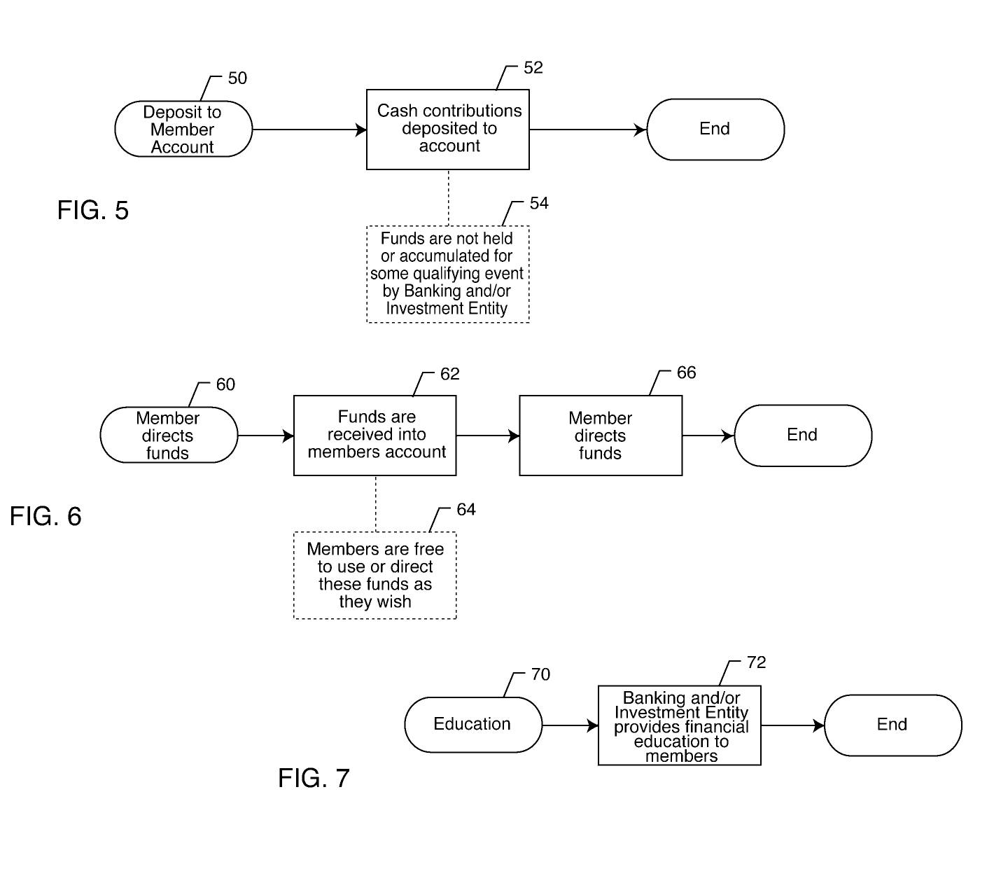

As shown in the drawings for purposes of illustration, the present invention discloses a process of consumer saving and investing under a plan participated in by a consumer and at least one commercial entity, and administered by a banking and/or investment entity, as seen in FIGS. 1-7. The consumer may be an individual person, or it may be a business entity, such as a partnership, limited liability company, corporation, foundation, trust, or other legal person that is capable of entering a binding contractual agreement to promote consumer savings and investment. The commercial entity includes, without limitation, an individual person acting as a vendor of goods and/or services, a business entity acting as a vendor of goods and/or services or a credit issuer or the like. The banking and/or investment entity is a company that sets up a system (e.g., an internet website, linked computer system, etc.) establishing relationships with commercial entities and consumers, to operate and administer the plan which connects commercial entities with consumers, educates consumers about finances, establishes accounts, and carries out the savings and investment directives of consumers participating in the plan. The banking and/or investment entity which owns, operates and administers the plan enters into agreements with commercial entities. These commercial entities agree to transfer monetary rewards offered to consumers also participating in the plan directly to an account(s) in the name of the consumer that is administered by the banking and/or investment entity. The plan allows consumers to select the direction of funds, the type of savings and/or investment and their risk profile for funds accumulated in their account. Consumers making purchases with commercial entities presenting coupons, retail savings cards, loyalty cards, and other forms of rebates may direct the savings portion into a saving/investment vehicle of their choice. The savings amount will be routed from the commercial entities into the account(s) of the consumer (by electronic or other means). The money saved will be routed from the commercial entities to the banking and/or investment entity. The money will then be routed from the banking and/or investment entity into a savings and/or investment account, including, without limitation, an individual retirement account (IRA), Roth-IRA, certificate of deposit, mutual fund, brokerage account, annuity, savings account or the like that the consumer has chosen to invest the accumulated monetary reward in their plan account.

The process starts (10) when an agreement is entered into between the consumer and the banking and/or investment entity whereby the consumer becomes a member of the plan (20). A consumer signs up to become a member of the plan by filling out an application. The application may be submitted to the banking and/or investment entity online at the website of the banking and/or investment entity, over the phone, by mail, or by other means. As part of the plan agreement, the consumer member agrees to have monetary rewards due them (as part of a commercial transaction with a commercial entity participating in the plan) routed to the plan account administered by the banking and/or investment entity. The consumer requests (22) that the banking and/or investment entity set up a plan account in the name of the consumer. The member's plan account is linked (24) to at least one non-plan account (e.g., the member's existing traditional bank checking and/or savings account) to enable monetary transfers.

A consumer who becomes a member of the plan is issued a unique member account created by the banking and/or investment entity (26). The membership account is identified by a membership number which is used as a key number for their plan account(s). The plan account(s) is where the monetary reward will be transferred to by the commercial entity. A unique membership number may be used for linking transactions to the member.

In one embodiment of the present invention, the membership number is provided on a membership card that also includes a magnetic strip with the member's information stored thereon.

In one embodiment of the present invention, the member can access their account by logging into their account at the website of the banking and/or investment entity. A new member may be issued a temporary password which should be changed upon their first login to a secure password. The member may also be issued a primary savings account and account numbers for that account.

The member is provided financial education by the banking and/or investment entity about uses for funds accumulated by the member under the plan. The banking and/or investment entity provides the member with information about various investments including, without limitation, IRAs, Roth-IRAs, certificates of deposit, mutual funds, savings accounts or the like. The consumer has total freedom to direct the funds accumulating in their plan account(s). For example, the consumer may direct that the specified funds be automatically transferred in response to a designated amount being accumulated under the plan. In another example, an investment or savings vehicle may be opened on behalf of the member at the direction of the member. Specified accumulated funds associated with the member are directed for a purpose(s) designated by the member.

Commercial transactions by members provide the members with funds for investment (30). A qualified transaction is engaged in under the plan when a member engages in a commercial transaction with a commercial entity participating in the plan (32). During the qualified transaction, the consumer is identified as a member of the plan (34). The identification may be made using a variety of means, including, but not limited to, electronically, by membership card, by driver's license or the like. In addition, a member may also be identified by the commercial entity having a system (e.g., computer network or the like) that recognizes, via an account held by the consumer with the commercial entity, that the consumer is a member of the plan. For example, a member may be recognized as being a member via the retailers' savings card numbers or phone numbers entered/accepted by the stores, merchants, retailers, and wholesalers. The commercial transaction generates a cash contribution (36) by electronically transferring a monetary reward offered as part of the commercial transaction into the member's plan account. The monetary reward includes, without limitation, vendor, sales, manufacturer's, credit, finance, or other incentive, rewards, discounts, direct rebates, coupons, savings cards, fees, cash-back incentives or any other rebates.

As part of completing the commercial transaction, the commercial transaction is linked with the plan account associated with the member under the plan and the commercial entity will route the monetary reward amount (e.g., electronically or otherwise) into the corresponding plan account belonging to the member that is administered by the banking and/or investment entity. The funds transferred into the plan account by the commercial entity and received by the banking and/or investment entity will then be transferred from the banking and/or investment entity into the member's plan account and then into the consumer's choice of investment (i.e., designated) account at the time and in the manner chosen by the member. The monetary reward is fully vested at the time of transfer and when received by the banking and/or investment entity.

The monetary reward transferred to the member's plan account is a cash contribution (40). As outlined above, transactions generate fully vested and owned cash contributions (42) and are transferred (e.g., electronically or otherwise) to the member's primary or designated account (44). Members may also make their own contributions to their account at any time (46) as the plan is not limited to monetary rewards and the member may contribute funds other than the monetary reward to the savings and investment account under the plan.

Funds for investment accumulate when deposited to the member's account (50). As outlined above, the monetary reward translates into a cash contribution deposited directly to the member's primary or designated accounts (52). The funds transferred into the member's account are not held or accumulated for some qualifying event by the banking and/or investment entity (54). On the contrary, the funds transferred into the member's account are held or accumulated only at the direction of the member who may direct that the funds be held for a qualifying event like the consumer directing that specified funds be held in the plan account but then automatically transferred in response to a designated amount being accumulated under the plan. The bottom line is that the member directs the funds (60). Once funds are received into a member's account (62), the member is free to use or direct these funds as they wish (64); funds which do not have to be directed into any specific type of investment.

The banking and/or investment entity can educate (70) the member and fully encourage the creation of firm financial structures and investments for the member but the member directs the funds (66) and there is no limitation on the member in directing these fully vested funds except as provided by law. The investment entity provides financial education to the member (72) in recognition of the widespread need for financial literacy and sophisticated education in the area of personal finance. A key component of the plan and member experience is the guided financial education system. Education is provided to all members of the plan as part of their basic service and is integral to the mission of the banking and/or investment entity.

In case a consumer already has an existing account at a financial institution, then the consumer may link their existing account to their plan account. At any time, the consumer member may direct funds to/from any of their linked accounts.

In one embodiment of the present invention, members can access their plan account at the banking and/or investment entity's website. Some website clients may select the direction of the investment, make ACH deposits or withdrawals to and from their plan account, and place trades of all types of equities and investments. Members can also make any necessary changes at the banking and/or investment entity website.

The above-described embodiments of the present invention are illustrative only and not limiting. It will thus be apparent to those skilled in the art that various changes and modifications may be made without departing from this invention in its broader aspects.

What is claimed is:

1. A process of consumer saving and investing under a plan participated in by a consumer and a commercial entity, and administered by a banking and/or investment entity, comprising the steps of:
entering into an agreement between the consumer and the banking and/or investment entity whereby the consumer becomes a member of the plan;
completing a commercial transaction between the member and the commercial entity;
generating a monetary reward on completion of the commercial transaction;
transferring the monetary reward to the banking and/or investment entity under the plan;
educating the member about uses for funds accumulated by the member under the plan; and
directing specified accumulated funds associated with the member, for a purpose designated by the member.

2. The process of claim 1, wherein the entering step includes the steps of opening an account under the plan at the request of the consumer, and administering the account by the banking and/or investment entity on behalf of the member.

3. The process of claim 1, wherein the entering step includes the step of linking a non-plan account associated with the member to the plan.

4. The process of claim 1, wherein the completing step includes the steps of linking the commercial transaction with an account associated with the member under the plan, and identifying the consumer as a member of the plan.

5. The process of claim 1, wherein the transferring step includes the step of receiving the monetary reward into an account associated with the member participating in the commercial transaction.

6. The process of claim 1, wherein the transferring step is performed by the commercial entity.

7. The process of claim 1, wherein the transferring step includes the step of vesting fully the monetary reward transferred under the plan at the time of transfer.

8. The process of claim 1, wherein the directing step includes the step of providing freedom to the member on use and direction of the specified funds.

9. The process of claim 1, wherein the directing step includes the step of automatically transferring the specified funds in response to a designated amount being accumulated under the plan.

10. The process of claim 1, wherein the directing step includes the step of opening an investment or savings vehicle on behalf of the member at the direction of the member.

11. The process of claim 1, wherein the educating step includes the step of providing financial education to the member by the banking and/or investment entity.

12. The process of claim 1, including the step of contributing funds other than the monetary reward to an account under the plan.

13. A process of consumer saving and investing under a plan participated in by a consumer and a commercial entity, and administered by a banking and/or investment entity, comprising the steps of:
entering into an agreement between the consumer and the banking and/or investment entity whereby the consumer becomes a member of the plan;
opening an account under the plan at the request of the consumer;
administering the account by the banking and/or investment entity on behalf of the member;
completing a commercial transaction between the member and the commercial entity;
linking the commercial transaction with the account associated with the member under the plan;
identifying the consumer as a member of the plan;
generating a monetary reward on completion of the commercial transaction;
transferring the monetary reward to the banking and/or investment entity under the plan;
educating the member about uses for funds accumulated by the member under the plan; and
directing specified accumulated funds associated with the member, for a purpose designated by the member.

14. The process of claim 13, wherein the entering step includes the step of linking a non-plan account associated with the member to the plan.

15. The process of claim 13, wherein the transferring step includes the step of receiving the monetary reward into the account associated with the member participating in the commercial transaction.

16. The process of claim 13, wherein the transferring step is performed by the commercial entity.

17. The process of claim 13, wherein the transferring step includes the step of vesting fully the monetary reward transferred under the plan at the time of transfer.

18. The process of claim 13, wherein the directing step includes the step of providing freedom to the member on use and direction of the specified funds.

19. The process of claim 13, wherein the directing step includes the step of automatically transferring the specified funds in response to a designated amount being accumulated under the plan.

20. The process of claim 13, wherein the directing step includes the step of opening an investment or savings vehicle on behalf of the member at the direction of the member.

21. The process of claim 13, wherein the educating step includes the step of providing financial education to the member by the banking and/or investment entity.

22. The process of claim 13, including the step of contributing funds other than the monetary reward to the account under the plan.

23. A process of consumer saving and investing under a plan participated in by a consumer and a commercial entity, and administered by a banking and/or investment entity, comprising the steps of:
entering into an agreement between the consumer and the banking and/or investment entity whereby the consumer becomes a member of the plan;
opening an account under the plan at the request of the consumer;
administering the account by the banking and/or investment entity on behalf of the member;
completing a commercial transaction between the member and the commercial entity;
linking the commercial transaction with the account associated with the member under the plan;
identifying the consumer as a member of the plan;
generating a monetary reward on completion of the commercial transaction;
transferring the monetary reward to the banking and/or investment entity under the plan;
receiving the monetary reward into the account associated with the member participating in the commercial transaction;
educating the member about uses for funds accumulated by the member under the plan;
providing financial education to the member by the banking and/or investment entity; and
directing specified accumulated funds associated with the member, for a purpose designated by the member.

24. The process of claim 23, wherein the entering step includes the step of linking a non-plan account associated with the member to the plan.

25. The process of claim 23, wherein the transferring step is performed by the commercial entity.

26. The process of claim 23, wherein the transferring step includes the step of vesting fully the monetary reward transferred under the plan at the time of transfer.

27. The process of claim 23, wherein the directing step includes the step of providing freedom to the member on use and direction of the specified funds.

28. The process of claim 23, wherein the directing step includes the step of automatically transferring the specified funds in response to a designated amount being accumulated under the plan.

29. The process of claim 23, wherein the directing step includes the step of opening an investment or savings vehicle on behalf of the member at the direction of the member.

30. The process of claim 23, including the step of contributing funds other than the monetary reward to the account under the plan.
